(19) United States
(12) Patent Application Publication
(10) Pub. No.: US 2020/0191592 A1
(43) Pub. Date: Jun. 18, 2020

(54) NAVIGATION DEVICE AND NAVIGATION METHOD

(71) Applicant: MITSUBISHI ELECTRIC CORPORATION, Tokyo (JP)

(72) Inventor: Masahiko UNO, Tokyo (JP)

(73) Assignee: MITSUBISHI ELECTRIC CORPORATION, Tokyo (JP)

(21) Appl. No.: 16/617,863

(22) PCT Filed: Jun. 26, 2017
(86) PCT No.: PCT/JP2017/023382

§ 371 Date: Nov. 27, 2019

(51) Int. Cl. G01C 21/36; G06F 40/20; G08G 1/0969

(52) U.S. Cl. CPC G01C 21/3602; G01C 21/3647; G08G 1/0969; G01C 21/3679; G06F 40/20; G01C 21/3629

(57) ABSTRACT

A search information acquiring unit acquires visual information about a destination. A search condition generating unit generates a search condition by using visual information about the destination, the visual information being acquired by the search information acquiring unit. An image information database has stored therein pieces of image information each about a neighborhood of a road and pieces of position information. A destination searching unit refers to the image information database, to search for image information satisfying the search condition generated by the search condition generating unit and set, as the destination, position information corresponding to the image information.

### TECHNICAL FIELD

The present invention relates to a navigation device for and a navigation method of providing guidance about a route from a place of departure to a destination.

### BACKGROUND ART

A conventional navigation system acquires route image data acquired by taking an image of a neighborhood of a route, and provides the route image data for the driver of a vehicle traveling along the route (for example, refer to Patent Literature 1).

### CITATION LIST

### Patent Literature

Patent Literature 1: JP 2014-85192 A

### SUMMARY OF INVENTION

### Technical Problem

A problem with the conventional navigation system is that the conventional navigation system only displays an image and provide visual route guidance, but it cannot search for a destination by using visual information about the destination.

The present invention is made in order to solve the above-mentioned problem, and it is therefore an object of the present invention to provide a technique for searching for a destination by using visual information about the destination.

### Solution to Problem

A navigation device according to the present invention includes: a search information acquiring unit for acquiring visual information about a destination; a search condition generating unit for generating a search condition by using the visual information about the destination, the visual information being acquired by the search information acquiring unit; and a destination searching unit for referring to an image information database having stored therein pieces of image information about a neighborhood of a road and pieces of position information about the neighborhood of the road, to search for image information satisfying the search condition generated by the search condition generating unit, and to set, as the destination, position information corresponding to the relevant image information.

### Advantageous Effects of Invention

According to the present invention, since the image information database having stored therein pieces of image information about a neighborhood of a road is referred to, and image information satisfying the search condition generated from the visual information about a destination is searched for and set as the destination, the destination can be searched for using the visual information about the destination.

### BRIEF DESCRIPTION OF DRAWINGS

FIG. 1 is a block diagram showing an example of the configuration of a navigation device according to an Embodiment 1;

FIG. 2 is a flow chart showing an example of the operation of the navigation device according to the Embodiment 1;

FIG. 3 is a block diagram showing an example of the configuration of a navigation device according to an Embodiment 2;

FIG. 4 is a flow chart showing an example of the operation of the navigation device according to the Embodiment 2;

FIGS. 5A, 5B, and 5C are diagrams showing an example of display of points satisfying a search condition in the Embodiment 2;

FIG. 6 is a diagram showing an example of display of points partially satisfying a search condition in the Embodiment 2;

FIG. 7 is a block diagram showing an example of the configuration of a navigation device according to an Embodiment 3;

FIG. 8 is a block diagram showing an example of the configuration of a navigation device according to an Embodiment 4;

FIG. 9 is a conceptual diagram showing an example of the configuration of a navigation device according to an Embodiment 5;

FIG. 10 is a block diagram showing an example of the configuration of the navigation device according to the Embodiment 5;

FIG. 11 is a block diagram showing an example of the configuration of a navigation device according to an Embodiment 6; and

FIGS. 12A and 12B are diagrams showing examples of the hardware configuration of the navigation device according to each of the embodiments.

### DESCRIPTION OF EMBODIMENTS

Hereinafter, in order to explain the present invention in greater detail, embodiments of the present invention will be described with reference to the accompanying drawings.

### Embodiment 1

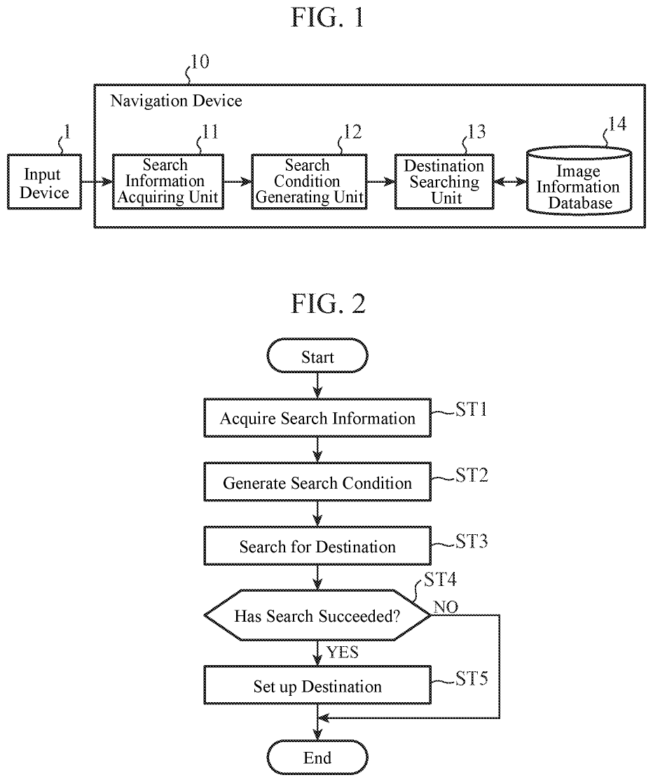

FIG. 1 is a block diagram showing an example of the configuration of a navigation device 10 according to an Embodiment 1. The navigation device 10 according to the Embodiment 1 searches for a destination by using visual information about the destination, such as “a house with a red roof” or “a triangle-shaped building with a brown wall.”

The navigation device 10 includes a search information acquiring unit 11, a search condition generating unit 12, a destination searching unit 13, and an image information database 14. Further, the navigation device 10 is connected to an input device 1. In the Embodiment 1, it is assumed that the navigation device 10 and the input device 1 are mounted in a vehicle.

Visual information about a destination is inputted to the input device 1. Not only the visual information about a destination but also information about a search range, etc. may be inputted to the input device 1. For example, when the inputted information is “a house with a red roof existing within a radius of 300 m”, the visual information is “a house with a red roof” and the information about the search range is “existing within a radius of 300 m.” The input device 1 is, for example, a microphone and a voice recognition device, a keyboard, or a touch panel.

The search information acquiring unit 11 acquires the visual information about a destination, the visual information being inputted to the input device 1, and so on, and outputs the visual information and so on to the search condition generating unit 12.

The search condition generating unit 12 generates a search condition by using the visual information about a destination and so on, which are received from the search information acquiring unit 11, and outputs the search condition to the destination searching unit 13. For example, when the visual information about a destination, and so on are not words, but a natural language, the search condition generating unit 12 analyzes the natural language, to decompose the natural language into tokens, each of which is a character string having a minimum meaningful word, and generates a search condition in which the relationship between tokens is clarified.

For example, when the visual information about a destination, and so on are “a house with a red roof existing within a radius of 300 m”, the search condition generating unit 12 decomposes these pieces of information into a token “within a radius of 300 m” showing the search range, a token “house, roof” showing a shape, a token “red” showing a color, and so on. Further, the search condition generating unit 12 analyzes the modification relation between tokens, and clarifies that something red is a roof, not a house.

The image information database 14 has stored therein pieces of image information each about a neighborhood of a road, and pieces of position information each showing a position of a neighborhood of a road, while bringing the pieces of image information and the pieces of position information into correspondence with each other.

The destination searching unit 13 refers to the image information database 14, and searches for image information satisfying the search condition received from the search condition generating unit 12. The destination searching unit 13 sets, as a destination, the position information corresponding to the image information satisfying the search condition.

More concretely, the destination searching unit 13 searches for the shape, the color, and so on of a structure or the like seen in an image on the basis of tokens, such as a shape and a color, which are visual information. Since a method of searching for a color in an image is a well-known technique, an explanation of the method will be omitted hereinafter. As a method of searching for a shape in an image, there are methods such as a method of performing a structure analysis on the image, or deep learning.

For example, when the search condition is a token “within a radius of 300 m” showing the search range, a token “house, roof” showing a shape, and a token “red” showing a color, the destination searching unit 13 searches for image information about an image in which a house with a red roof is seen, out of pieces of image information each having position information showing a position included within the region having a radius of 300 m and centered at the position of the vehicle or a place of departure specified by a user.

When no token showing the search range is included, the destination searching unit 13 can use a preset value (e.g., a radius of 5 km) as the search range.

Although not illustrated, the navigation device 10 may include a function of acquiring information about the current position of the vehicle in which the navigation device 10 is mounted, a function of searching for a route from the current position or the place of departure to a destination, a function of providing guidance about the route searched for, and so on.

Next, an example of the operation of the navigation device 10 according to the Embodiment 1 will be explained. FIG. 2 is a flow chart showing an example of the operation of the navigation device 10 according to the Embodiment 1.

In step ST1, the search information acquiring unit 11 acquires visual information about a destination, and so on from the input device 1.

In step ST2, the search condition generating unit 12 generates a search condition by using the visual information about a destination, the visual information being acquired by the search information acquiring unit 11.

In step ST3, the destination searching unit 13 refers to the image information database 14, to search for image information satisfying the search condition generated by the search condition generating unit 12.

In step ST4, when image information satisfying the search condition exists in the image information database 14 (when “YES” in step ST4), the destination searching unit 13 proceeds to step ST5, whereas when no image information satisfying the search condition exists in the image information database 14 (when “NO” in step ST4), the destination searching unit skips step ST5.

In step ST5, the destination searching unit 13 sets, as a destination, the position information corresponding to the image information satisfying the search condition. When there are multiple pieces of image information satisfying the search condition, that is, when there are multiple candidates for destination, one destination is selected finally by the user.

As mentioned above, the navigation device 10 according to the Embodiment 1 includes the search information acquiring unit 11, the search condition generating unit 12, the destination searching unit 13, and the image information database 14. The search information acquiring unit 11 acquires visual information about a destination. The search condition generating unit 12 generates a search condition by using the visual information about a destination, the visual information being acquired by the search information acquiring unit 11. The image information database 14 has stored therein pieces of image information each about a neighborhood of a road and pieces of position information. The destination searching unit 13 refers to the image information database 14, to search for image information satisfying the search condition generated by the search condition generating unit 12 and set, as a destination, the position information corresponding to the image information. As a result, a destination can be searched for using the visual information about the destination.

In the Embodiment 1, the image information database 14 is not an indispensable component. The destination searching unit 13 of the navigation device 10 may refer to an information source having the same pieces of information as those of the image information database 14. The information source having the same pieces of information as those of the image information database 14 is, for example, “Street View (registered trademark)” provided by Google Inc.

Further, the search information acquiring unit 11 of the Embodiment 1 acquires a result of voice recognition of visual information about a destination, the visual information being inputted via voice. The search condition generating unit 12 performs a natural language analysis on the voice recognition result acquired by the search information acquiring unit 11, and generates a search condition. As a result, users can input visual information about a destination only by speaking into a microphone without operating a keyboard or the like, so that the input operation is facilitated. When the amount of input operation is large and therefore it is not convenient to perform input using a keyboard or the like, voice input is effective.

### Embodiment 2

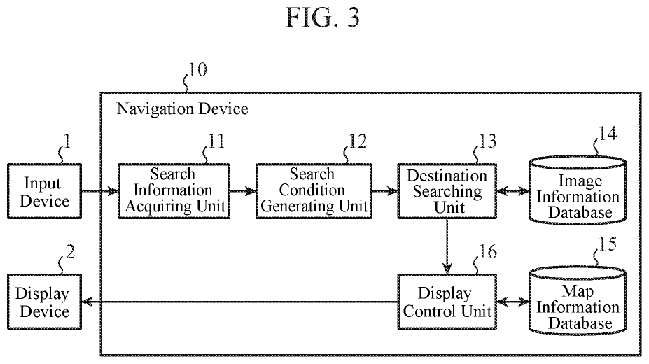

FIG. 3 is a block diagram showing an example of the configuration of a navigation device 10 according to an Embodiment 2. The navigation device 10 according to the Embodiment 2 has a configuration in which a map information database 15 and a display control unit 16 are added to the navigation device 10 of the Embodiment 1 shown in FIG. 1. Further, a display device 2 is connected to the navigation device 10. In FIG. 3, the same components as those of FIG. 1 or like components are denoted by the same reference signs, and an explanation of the components will be omitted hereinafter.

The map information database 15 has stored therein pieces of map information. The pieces of map information include pieces of information about maps, and the positions, the names, the addresses, etc. of structures.

Although, in the Embodiment 1, an image information database 14 has stored therein pieces of image information and pieces of position information while bringing the pieces of image information and the pieces of position information into correspondence with each other, in the Embodiment 2, an image information database 14 may not have stored therein position information, and pieces of image information may be brought into correspondence with pieces of map information in the map information database 15.

The display control unit 16 refers to the map information database 15, to generate display information for displaying a destination searched for by a destination searching unit 13 on map information or in a list. The display control unit 16 outputs the generated display information to a display device 2.

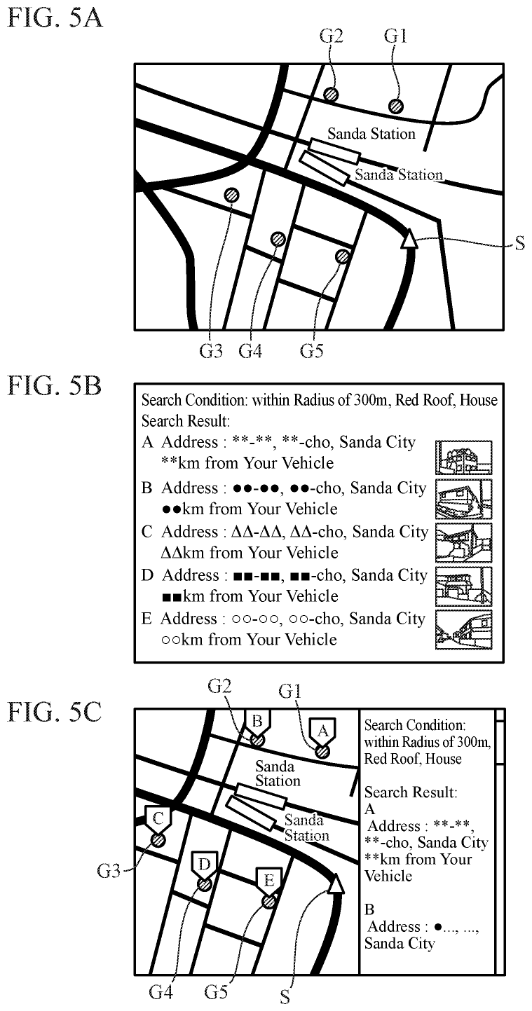

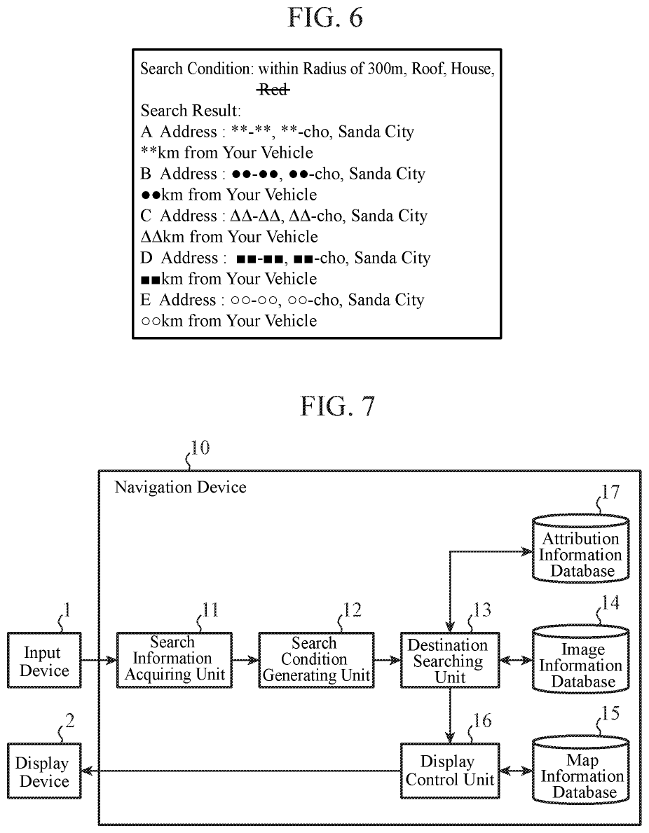

The display device 2 displays the display information received from the display control unit 16. The display device 2 is, for example, a display. Examples of a screen displayed by the display device 2 will be explained in detail in FIGS. 5 and 6.

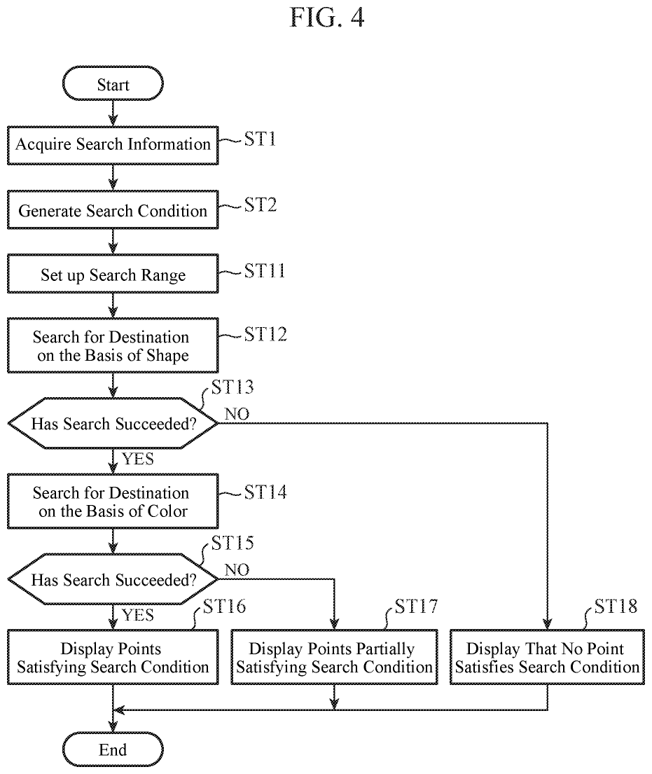

Next, an example of the operation of the navigation device 10 according to the Embodiment 2 will be explained. FIG. 4 is a flow chart showing an example of the operation of the navigation device 10 according to the Embodiment 2. Processes in steps ST1 and ST2 of FIG. 4 are the same as those in steps ST1 and ST2 of FIG. 2.

In step ST11, when a token showing a search range is included in a search condition, the destination searching unit 13 sets up the search range in accordance with the token. When no token showing the search range is included, the destination searching unit 13 sets a preset value (e.g., a radius of 5 km) as the search range.

In step ST12, the destination searching unit 13 refers to the image information database 14, and to search for image information satisfying a token included in the search condition and showing a shape, out of pieces of image information within the search range set up in step ST11.

In step ST13, when one or more pieces of image information satisfying the token showing a shape exist (when “YES” in step ST13), the destination searching unit 13 proceeds to step ST14, whereas when no image information satisfying the token showing a shape exists (when “NO” in step ST13), the destination searching unit outputs a search result to the display control unit 16 and proceeds to step ST18.

In step ST14, the destination searching unit 13 refers to the image information database 14, to search for image information satisfying a token showing a color, out of the one or more pieces of image information searched for in step ST12 and satisfying the token showing a shape. More specifically, the searching process of step ST14 is a narrowing down search.

In step ST15, when one or more pieces of image information satisfying the token showing a color exist (when “YES” in step ST15), the destination searching unit 13 outputs a search result to the display control unit 16 and proceeds to step ST16. In contrast, when no image information satisfying the token showing a color exists (when “NO” in step ST15), the destination searching unit 13 outputs a search result to the display control unit 16 and proceeds to step ST17.

In step ST16, the display control unit 16 causes the display device 2 to display the one or more points based on the one or more pieces of position information corresponding to the one or more pieces of image information satisfying the search condition. These “points” are candidates for destination. When there are multiple candidates for destination, one destination is selected finally by a user.

In step ST17, the display control unit 16 causes the display device 2 to display the one or more points based on the one or more pieces of position information corresponding to the one or more pieces of image information partially satisfying the search condition. In the case of the operation example of FIG. 4, a partially-satisfying point is a point that satisfies the token showing a shape, but does not satisfy the token showing a color.

In step ST18, the display control unit 16 causes the display device 2 to display that there is no point satisfying the search condition.

Next, examples of the display of a search result will be explained.

FIGS. 5A, 5B, and 5C are diagrams showing the examples of the display of points satisfying the search condition in the Embodiment 2. The display examples of FIGS. 5A, 5B, and 5C are ones in which the display control unit 16 causes the display device 2 to display points in step ST16 of FIG. 4.

FIG. 5A is a diagram showing an example of displaying points satisfying the search condition on a map in the Embodiment 2. The destination searching unit 13 searches for a house with a red roof existing within a radius of 300 m from a vehicle position S, and acquires points G1 to G5 satisfying the search condition. The display control unit 16 generates display information in which a triangular mark showing the vehicle position S and round marks showing the points G1 to G5 are superimposed onto map information stored in the map information database 15, and causes the display device 2 to display the display information. When the points G1 to G5 that are search results are shown on a map, as shown in FIG. 5A, the user can easily select a destination by using, as a criterion of judgment, the distances from the vehicle position S to the points G1 to G5.

FIG. 5B is a diagram showing an example of displaying points satisfying the search condition in a list in the Embodiment 2. The destination searching unit 13 searches for a house with a red roof existing within a radius of 300 m from the vehicle position, and acquires points A to E satisfying the search condition. The display control unit 16 generates display information in which the addresses, the distances from the vehicle, and so on of the points A to E are listed, by using map information stored in the map information database 15, and causes the display device 2 to display the display information. At that time, the display control unit 16 may arrange a point nearer to the vehicle position at a higher position in the list. When the points A to E that are search results are displayed as a list, as shown in FIG. 5B, the user can easily determine that which one of the points A to E is appropriate as a destination.

The display control unit 16 may display the pieces of image information about the points A to E, a thumbnail of structures satisfying the search condition and extracted from the pieces of image information, or the like, next to the addresses or the likes of the points A to E. The user can determine more easily that which one of the points A to E is appropriate as a destination.

FIG. 5C is a diagram showing an example of displaying the points satisfying the search condition on a map in a list in the Embodiment 2. The display control unit 16 superimposes round marks showing the points G1 to G5 and character icons “A” to “E” onto map information. The display control unit 16 also makes a list of the addresses of, the pieces of image information about, or the likes of the points A to E corresponding to the points G1 to G5, and arranges this list next to the map information.

FIG. 6 is a diagram showing an example of displaying points partially satisfying the search condition in the Embodiment 2. The display example of FIG. 6 is one in which the display control unit 16 causes the display device 2 to display the points in step ST17 of FIG. 4. The destination searching unit 13 searches for a house with a red roof existing within a radius of 300 m from the vehicle position, and acquires points A to E partially satisfying the search condition. The display control unit 16 generates display information in which the addresses, the distances from the vehicle, and so on of the points A to E are listed, by using map information stored in the map information database 15, and causes the display device 2 to display the display information. At that time, the display control unit 16 draws a strikethrough on a search condition “red” that is not satisfied. As a method of notifying the user of a search condition that is not satisfied, another method other than the method of drawing a strikethrough may be used.

As mentioned above, the navigation device 10 according to the Embodiment 2 includes the map information database 15 and the display control unit 16. The map information database 15 has stored therein pieces of map information. The display control unit 16 refers to the map information database 15, to generate display information for displaying a destination searched for by the destination searching unit 13 on map information, displaying the destination in a list, or displaying the destination on map information while displaying the destination in a list. As a result, convenient display of a destination can be performed in accordance with the user's object.

In the Embodiment 2, the map information database 15 is not an indispensable component. The display control unit 16 of the navigation device 10 may refer to an information source having the same pieces of information as those of the map information database 15.

### Embodiment 3

FIG. 7 is a block diagram showing an example of the configuration of a navigation device 10 according to an Embodiment 3. The navigation device 10 according to the Embodiment 3 has a configuration in which an attribution information database 17 is added to the navigation device 10 of the Embodiment 2 shown in FIG. 3. In FIG. 7, the same components as those of FIG. 3 or like components are denoted by the same reference signs, and an explanation of the components will be omitted hereinafter.

The attribution information database 17 has stored therein pieces of attribution information in each of which visual information related to image information stored in an image information database 14 is converted into a text. More specifically, attribution information is a character string showing visual information such as the shape or the color of a structure or the like.

Attribution information is, for example, the shape of a structure, the color of a roof, the color of a wall, or the color of a door. The shape of a structure is a residence, a building, an apartment, a monument, or the like. The colors of a roof, a wall, and a door are red, blue, and white, or the likes. The attribution information database 17 has stored therein pieces of visual information each about a structure seen in an image, as character strings that are easier to search for than images, thereby making it possible to shorten the time required for a destination searching unit 13 to make a search, and reduce the amount of calculation needed for the search.

The attribution information database 17 may have stored therein the pieces of attribution information and pieces of position information while bringing the pieces of attribution information and the pieces of position information into correspondence with each other, or may bring each attribution information into correspondence with at least one of position information stored in the image information database 14 and map information stored in a map information database 15.

The destination searching unit 13 refers to the image information database 14 and the attribution information database 17, to search for either image information or attribution information satisfying a search condition and set, as a destination, the position information corresponding to either the image information or the attribution information.

For example, the destination searching unit 13 refers to the attribution information database 17 first, to search for attribution information satisfying the search condition, and, when no attribution information satisfying the search condition exists, refers to the image information database 14, to search for image information satisfying the search condition. Searching for the attribution information database 17 first leads to a shortening of the search time and a reduction in the amount of calculation needed for the search. Further, visual information in which image information is not converted into a text can be searched for by searching through the image information database 14 after searching through the attribution information database 17.

As mentioned above, the destination searching unit 13 of the Embodiment 3 refers to the attribution information database 17 that has stored therein pieces of attribution information in each of which visual information related to image information stored in the image information database 14 is converted into a text, to search for attribution information satisfying a search condition generated by a search condition generating unit 12. In the case of searching through the attribution information database 17, the destination searching unit 13 can make a search at a high speed, as compared with the case of searching through the image information database 14.

Although, in the Embodiment 3, the configuration in which the attribution information database 17 is added to the navigation device 10 of the Embodiment 2 is shown, and the present invention is not limited to this configuration, and the attribution information database 17 may be added to the navigation device 10 of the Embodiment 1.

Further, the attribution information database 17 is not an indispensable component. The destination searching unit 13 of the navigation device 10 may refer to an information source having the same pieces of information as those of the attribution information database 17.

### Embodiment 4

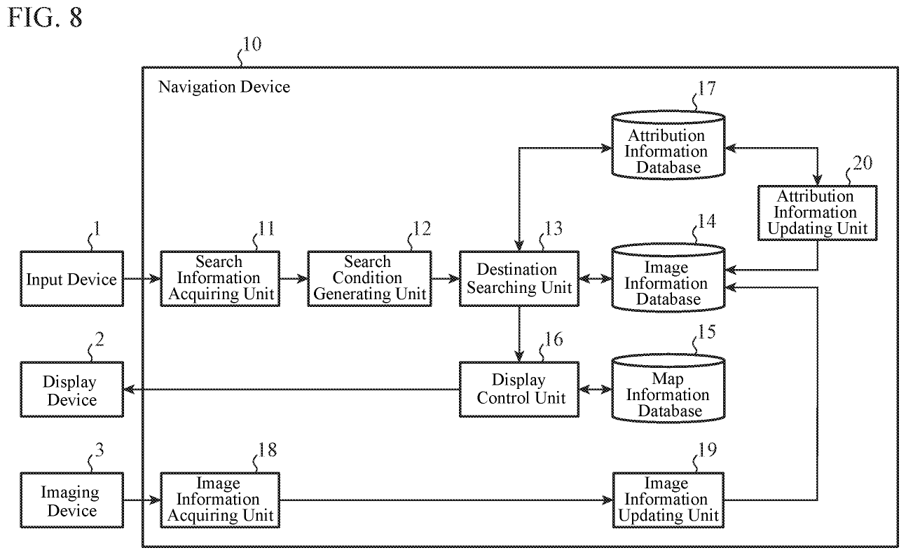

FIG. 8 is a block diagram showing an example of the configuration of a navigation device 10 according to an Embodiment 4. The navigation device 10 according to the Embodiment 4 has a configuration in which an image information acquiring unit 18, an image information updating unit 19, and an attribution information updating unit 20 are added to the navigation device 10 of the Embodiment 3 shown in FIG. 7. Further, an imaging device 3 is connected to the navigation device 10. In FIG. 8, the same components as those of FIG. 7 or like components are denoted by the same reference signs, and an explanation of the components will be omitted hereinafter.

The imaging device 3 outputs information about an image acquired by taking an image of a neighborhood of a road to the navigation device 10. The information about the image shot by the imaging device 3 is added to an image information database 14. The imaging device 3 is, for example, externally-mounted cameras mounted at four points: front, rear, right, and left points of a vehicle.

The image information acquiring unit 18 acquires the image information about the neighborhood of the road from the imaging device 3, and outputs the image information to the image information updating unit 19.

The image information updating unit 19 updates the image information database 14 by adding the image information received from the image information acquiring unit 18 to the image information database 14. At this time, the image information acquiring unit 18 adds position information showing the position at which the imaging device 3 has shot the image and acquired the image information to the image information database 14 while bringing the position information into correspondence with this image information. The image information acquiring unit 18 alternatively adds the information about the image shot by the imaging device 3 to the image information database 14 while bringing the image information into correspondence with map information corresponding to the shooting position and stored in a map information database 15.

The attribution information updating unit 20 uses the image information stored in the image information database 14, to generate attribution information in which visual information related to this image information is extracted and converted into a text, and adds this attribution information to an attribution information database 17. At this time, the attribution information updating unit 20 may have stored therein the position information brought into correspondence with the image information while also bringing the position information into correspondence with the attribution information. As an alternative, the attribution information updating unit 20 may have stored therein only the attribution information in the attribution information database 17, and bring this attribution information into correspondence with at least one of the position information stored in the image information database 14 and the map information stored in the map information database 15.

More concretely, the attribution information updating unit 20 extracts information such as the shape and the color of a structure or the like seen in the image, and converts the information into a text. Since a method of extracting a color on an image is a well-known technique, an explanation of the method will be omitted hereinafter. As a method of extracting a shape on an image, there are methods such as a method of performing a structure analysis on the image, or deep learning.

As an alternative, a person may extract information such as the shape and the color of a structure or the like seen in the image and convert the information into a text, and generate attribution information, and the attribution information updating unit 20 may update the attribution information database 17 by using this attribution information.

Although the timing at which the attribution information updating unit 20 updates the attribution information database 17 may be arbitrary, it is preferable to perform the update at the same time as or immediately after the update of the image information database 14.

For example, when the image information database 14 is updated by the image information updating unit 19, the attribution information updating unit 20 generates attribution information by using the image information newly added to the image information database 14, and updates the attribution information database 17.

After generating attribution information by using the image information added to the image information database 14 and updating the attribution information database 17, the attribution information updating unit 20 may delete this image information from the image information database 14. More specifically, after the image information has been added, the image information database 14 has stored therein this image information only until the attribution information database 17 is updated on the basis of this image information. In this case, since the image information does not exist in the image information database 14 basically, a destination searching unit 13 uses only the attribution information database 17 for destination search without using the image information database 14.

As mentioned above, the navigation device 10 according to the Embodiment 4 includes the image information acquiring unit 18 and the image information updating unit 19. The image information acquiring unit 18 acquires image information about a neighborhood of a road. The image information updating unit 19 updates the image information database 14 by adding the image information acquired by the image information acquiring unit 18 to the image information database 14. As a result, as to an area about which image information is not stored in the image information database 14, image information can be added. When image information is stored in the image information database 14, the image information can be updated to the newest one.

In a case in which an existing information source such as “Street View (registered trademark)” is used as the image information database 14, image information may be partially missing from the viewpoint of protection of privacy. Also at that time, it is possible to add and update image information. Therefore, it is possible to make a search with the newest pieces of image information and without loss of information.

Further, the navigation device 10 according to the Embodiment 4 includes the attribution information updating unit 20. The attribution information updating unit 20 generates attribution information in which visual information related to image information is extracted and converted into a text, and updates the attribution information database 17 by adding this attribution information to the attribution information database 17. As a result, the attribution information database 17 can be constituted automatically.

Further, when the image information database 14 is updated, the attribution information updating unit 20 of the Embodiment 4 updates the attribution information database 17 by using the image information added to the image information database 14. Since an update of the attribution information database 17 is performed in accordance with an update of the image information database 14, it is possible to make a search with the newest pieces of image information and without loss of information.

Further, when the image information database 14 is updated, the attribution information updating unit 20 of the Embodiment 4 updates the attribution information database 17 by using the image information added to the image information database 14, and, after that, deletes the image information from the image information database 14. As a result, since the image information database 14 does not have to store therein image information having a large data volume at all times, the data volume of the image information database 14 can be reduced.

Although, in the Embodiment 4, the configuration in which the image information acquiring unit 18, the image information updating unit 19, and the attribution information updating unit 20 are added to the navigation device 10 of the Embodiment 3 is shown, the present invention is not limited to this configuration, and the image information acquiring unit 18 and the image information updating unit 19 may be added to the navigation devices 10 of the Embodiments 1 to 3. Further, the attribution information updating unit 20 may be added to the navigation device 10 of the Embodiment 3.

### Embodiment 5

Although, in the Embodiments 1 to 4, configuration examples in which all the functions of the navigation device 10 are in a vehicle are explained, all or part of the functions of the navigation device 10 may be in a server outside the vehicle.

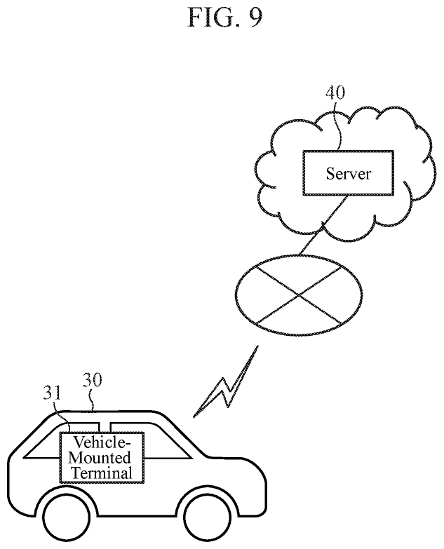

FIG. 9 is a conceptual diagram showing an example of the configuration of a navigation device 10 according to an Embodiment 5. Part of the functions of the navigation device 10 are included by a vehicle-mounted terminal 31 mounted in a vehicle 30. Part of the functions of the navigation device 10 are included by a server 40. The navigation device 10 of the Embodiment 5 is constituted by the vehicle-mounted terminal 31 and the server 40. The vehicle-mounted terminal 31 and the server 40 can communicate with each other via, for example, the Internet.

The server 40 may be a cloud server.

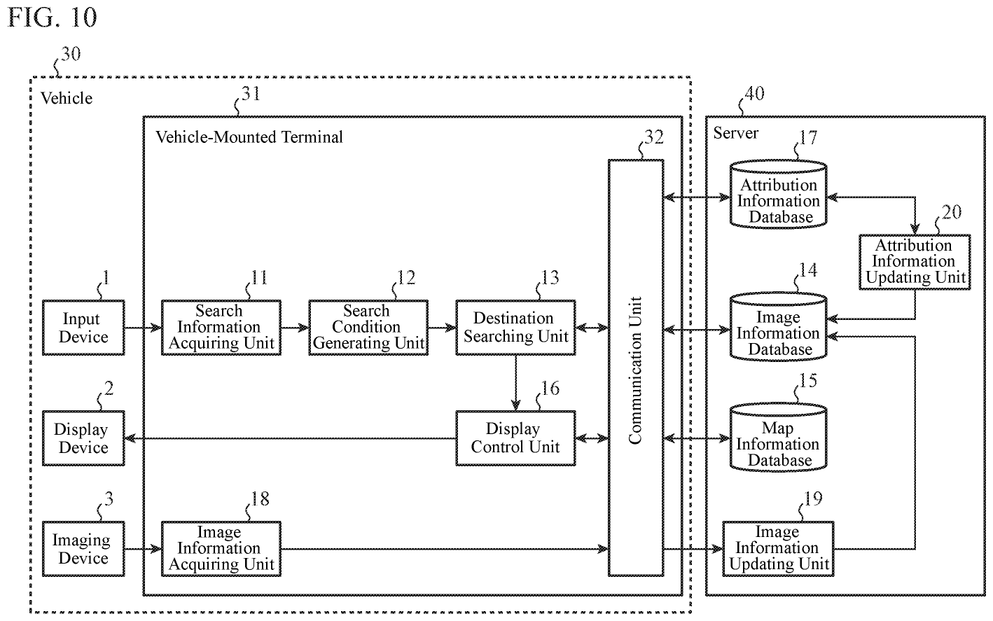

FIG. 10 is a block diagram showing an example of the configuration of the navigation device 10 according to the Embodiment 5. In FIG. 10, the same components as those of FIG. 8 of the Embodiment 4 or like components are denoted by the same reference signs, and an explanation of the components will be omitted hereinafter.

In the configuration example of FIG. 10, the vehicle-mounted terminal 31 includes a communication unit 32, a search information acquiring unit 11, a search condition generating unit 12, a destination searching unit 13, a display control unit 16, and an image information acquiring unit 18. On the other hand, the server 40 includes an image information database 14, a map information database 15, an attribution information database 17, an image information updating unit 19, and an attribution information updating unit 20.

Hereinafter, an example of the operation of the navigation device 10 according to the Embodiment 5 will be explained focusing on a part different from that of the navigation device 10 according to the Embodiment 4.

The communication unit 32 performs wireless communications with the server 40 outside the vehicle, to send and receive information. Although, in the illustrated example, the image information database 14, the map information database 15, and the attribution information database 17 are configured on the single server 40, the present invention is not limited to this configuration, and the databases may be distributed among multiple servers.

The destination searching unit 13 refers to at least one of the image information database 14 and the attribution information database 17 via the communication unit 32, to search for at least one of image information and attribution information that satisfy a search condition generated by the search condition generating unit 12.

The display control unit 16 refers to the map information database 15 via the communication unit 32, to generate display information for displaying a destination searched for by the destination searching unit 13 on map information or in a list.

The image information acquiring unit 18 acquires image information about a neighborhood of a road from an imaging device 3, and outputs the image information to the image information updating unit 19 via the communication unit 32. The image information updating unit 19 updates the image information database 14 by using the image information acquired via the communication unit 32.

As mentioned above, the image information database 14, the map information database 15, and the attribution information database 17 of the Embodiment 5 are on the server 40 outside the vehicle. In the case in which these databases are configured on the server 40 outside the vehicle, the data volumes of the databases can be increased.

Further, the image information updating unit 19 and the attribution information updating unit 20 of the Embodiment 5 are on the server 40 outside the vehicle. In the case in which the image information database 14 and the attribution information database 17 are configured on the server 40, since these databases can be accessed at a high speed by configuring the image information updating unit 19 and the attribution information updating unit 20 on the server 40, the databases can be updated at a high speed.

Further, since the attribution information updating unit 20 has a large amount of calculation, by implementing the attribution information updating unit 20 by using the server 40 constituted by a high-speed computer, it is possible to achieve a reduction in the calculation load on the vehicle-mounted terminal 31 and a shortening of the time required to update the database as a result.

On the other hand, also in a case in which the image information database 14 and the image information updating unit 19 are configured on the vehicle-mounted terminal 31, just like in the case of the Embodiment 4, or in a case in which the attribution information database 17 and the attribution information updating unit 20 are configured on the vehicle-mounted terminal 31, since this database can be accessed at a high speed, the database can be updated at a high speed.

In a case in which the image information database 14 is configured on the server 40 on a cloud, no problem in privacy arises as long as a data lock is applied to the image information added by the image information updating unit 19 in such a way that those that can refer to the image information are limited only to the vehicle-mounted terminal 31 in the vehicle 30 that has shot an image and acquired the image information.

Although, in the Embodiment 5, the search information acquiring unit 11, the search condition generating unit 12, the destination searching unit 13, the display control unit 16, and the image information acquiring unit 18 are configured on the vehicle-mounted terminal 31, the units may be alternatively configured on the server 40.

For example, in the case in which the image information database 14 and the attribution information database 17 are configured on the server 40, since the destination searching unit 13 can access these databases at a high speed by also configuring the destination searching unit 13 on the server 40, the responsivity is improved.

Further, since the destination searching unit 13 has a large amount of calculation, by implementing the destination searching unit 13 by using the server 40 constituted by a high-speed computer, it is possible to achieve a reduction in the calculation load on the vehicle-mounted terminal 31 and a shortening of the time required to make a search as a result.

On the other hand, also in a case in which the image information database 14, the attribution information database 17, and the destination searching unit 13 are configured on the vehicle-mounted terminal 31, just like in the case of the Embodiment 4, since the destination searching unit 13 can access these databases at a high speed, the responsivity is improved.

Further, in a case in which the image information database 14 and the attribution information database 17 are configured at different locations, the destination searching unit 13 may be decomposed into means for searching through the image information database 14 and means for searching through the attribution information database 17, and these means may be arranged distributedly at the locations where the databases are configured.

For example, in a case in which the image information database 14 is in the vehicle-mounted terminal 31, part of the destination searching unit 13, i.e., means for searching through the image information database 14 is also arranged in the vehicle-mounted terminal 31. On the other hand, in a case in which the attribution information database 17 is in the server 40, part of the destination searching unit 13, i.e., means for searching through the attribution information database 17 is also arranged in the server 40. Since this arrangement makes it possible for each means of the destination searching unit 13 to access the corresponding database at a high speed, the responsivity is improved.

Just like in the Embodiment 5, the functions provided by the navigation device 10 are distributed between the vehicle-mounted terminal 31 and the server 40 also in the Embodiments 1 to 4.

### Embodiment 6

Although, in the Embodiments 1 to 5, the configuration example in which the navigation device 10 includes the image information database 14 is explained, the navigation device may be configured so as not to include the image information database 14, but include only the attribution information database 17.

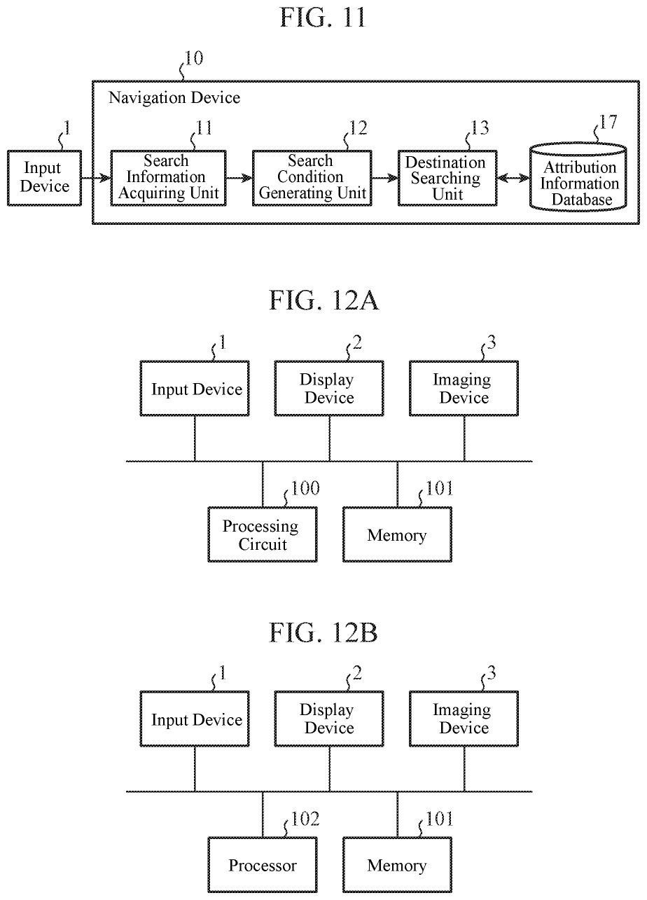

FIG. 11 is a block diagram showing an example of the configuration of a navigation device 10 according to an Embodiment 6. In FIG. 11, the same components as those of FIG. 1 of the Embodiment 1 or like components are denoted by the same reference signs, and an explanation of the components will be omitted hereinafter.

In the configuration example of FIG. 11, the navigation device 10 includes a search information acquiring unit 11, a search condition generating unit 12, a destination searching unit 13, and an attribution information database 17.

The time required to search for attribution information in the attribution information database 17 whenever the destination searching unit 13 searches for a destination can be made to be shorter than that required to search for image information in an image information database 14 whenever the destination searching unit 13 searches for a destination. Further, the amount of calculation needed for search can also be reduced. Therefore, the destination searching unit 13 intended for searching through the attribution information database 17 is inexpensive and more compact than a destination searching unit 13 intended for searching through the image information database 14.

Just like in the Embodiment 6, the navigation device 10 may not include the image information database 14, but may include the attribution information database 17 also in the Embodiments 2 to 5.

Finally, examples of the hardware configuration of the navigation device 10 according to each of the embodiments will be explained.

FIGS. 12A and 12B are diagrams showing examples of the hardware configuration of the navigation device 10 according to each of the embodiments. Each of the functions of the search information acquiring unit 11, the search condition generating unit 12, the destination searching unit 13, the display control unit 16, the image information acquiring unit 18, the image information updating unit 19, and the attribution information updating unit 20 in the navigation device 10 is implemented by a processing circuit. More specifically, the navigation device 10 includes a processing circuit for implementing each of the above-mentioned functions. The processing circuit may be a processing circuit 100 as hardware for exclusive use, or may be a processor 102 that executes a program stored in a memory 101.

Further, the image information database 14, the map information database 15, and the attribution information database 17 in the navigation device 10 are the memory 101.

The processing circuit 100, the processor 102, and the memory 101 are connected to the input device 1, the display device 2, and the imaging device 3.

As shown in FIG. 12A, in the case in which the processing circuit is hardware for exclusive use, the processing circuit 100 is, for example, a single circuit, a composite circuit, a programmable processor, a parallel programmable processor, an application specific integrated circuit (ASIC), a field programmable gate array (FPGA), or a combination of these circuits. The functions of the search information acquiring unit 11, the search condition generating unit 12, the destination searching unit 13, the display control unit 16, the image information acquiring unit 18, the image information updating unit 19, and the attribution information updating unit 20 may be implemented by multiple processing circuits 100, or the functions of these units may be implemented collectively by a single processing circuit 100.

As shown in FIG. 12B, in the case in which the processing circuit is the processor 102, the functions of the search information acquiring unit 11, the search condition generating unit 12, the destination searching unit 13, the display control unit 16, the image information acquiring unit 18, the image information updating unit 19, and the attribution information updating unit 20 are implemented by software, firmware, or a combination of software and firmware. The software or the firmware is described as a program and the program is stored in the memory 101. The processor 102 implements the functions of these units by reading and executing the program stored in the memory 101. More specifically, the navigation device 10 includes the memory 101 having stored therein the program in which the steps shown in the flow chart of FIG. 2 or 4 are performed as a result when the program is executed by the processor 102. Further, it can be said that this program causes a computer to execute procedures or methods using the search information acquiring unit 11, the search condition generating unit 12, the destination searching unit 13, the display control unit 16, the image information acquiring unit 18, the image information updating unit 19, and the attribution information updating unit 20.

Here, the memory 101 may be a non-volatile or volatile semiconductor memory such as a random access memory (RAM), a read only memory (ROM), an erasable programmable ROM (EPROM), or a flash memory, a magnetic disc such as a hard disc or a flexible disc, or an optical disc such as a compact disc (CD) or a digital versatile disc (DVD).

The processor 102 is a central processing unit (CPU), a processing device, an arithmetic device, a microprocessor, a microcomputer, or the like.

Part of the functions of the search information acquiring unit 11, the search condition generating unit 12, the destination searching unit 13, the display control unit 16, the image information acquiring unit 18, the image information updating unit 19, and the attribution information updating unit 20 may be implemented by hardware for exclusive use, and part of the functions may be implemented by software or firmware. In this way, the processing circuit in the navigation device 10 can implement the above-mentioned functions by using hardware, software, firmware, or a combination of hardware, software, and firmware.

It is to be understood that any combination of two or more of the above-mentioned embodiments can be made, various changes can be made in any component according to any one of the above-mentioned embodiments, and any component according to any one of the above-mentioned embodiments can be omitted within the scope of the present invention.

### INDUSTRIAL APPLICABILITY

Since the navigation device according to the present invention is configured so as to search for a destination by using visual information about the destination, the navigation device is suitable for use as a navigation device for moving objects including persons, vehicles, railroad cars, ships, or airplanes, particularly for a navigation device suitable for being carried into or mounted in a vehicle.

### REFERENCE SIGNS LIST

1: input device,
2: display device,
3: imaging device,
10: navigation device,
11: search information acquiring unit,
12: search condition generating unit,
13: destination searching unit,
14: image information database,
15: map information database,
16: display control unit,
17: attribution information database,
18: image information acquiring unit,
19: image information updating unit,
20: attribution information updating unit,
30: vehicle,
31: vehicle-mounted terminal,
32: communication unit,
40: server,
100: processing circuit,
101: memory,
102: processor,
A to E, G1 to G5: point, and
S: vehicle position.

1.-16. (canceled)

17. A navigation device comprising:
a processor to execute a program; and
a memory to store the program which, when executed by the processor, the processor performs processes of,
acquiring visual information about a destination;
generating a search condition by using the visual information about the destination, the visual information being acquired by the processor; and
referring to an image information database having stored therein pieces of image information each about a neighborhood of a road and pieces of position information, to search for image information satisfying the search condition generated by processor, and to set, as the destination, position information corresponding to the image information.

18. The navigation device according to claim 17, wherein
the processor further performs processes of,
acquiring a result of voice recognition of visual information about the destination, the visual information being inputted via voice, and
performing a natural language analysis on the voice recognition result acquired by the processor, to generate a search condition.

19. The navigation device according to claim 17, wherein
the processor further performs processes of referring to a map information database having map information stored therein, to generate display information for displaying the destination searched for by the processor on the map information, displaying the destination in a list, or displaying the destination on the map information while displaying the destination in a list.

20. The navigation device according to claim 17, wherein the image information database is on a server inside or outside a vehicle.

21. The navigation device according to claim 19, wherein the map information database is on a server inside or outside a vehicle.

22. The navigation device according to claim 17, wherein the processor is on a server inside or outside a vehicle.

23. The navigation device according to claim 17, wherein
the processor further performs processes of referring to an attribution information database having stored therein pieces of attribution information in each of which visual information related to image information stored in the image information database is converted into a text, to search for attribution information satisfying the search condition generated by the processor.

24. The navigation device according to claim 23, wherein the attribution information database is on a server inside or outside a vehicle.

25. The navigation device according to claim 17, wherein
the processor further performs processes of
acquiring image information about a neighborhood of a road; and
updating the image information database by adding the image information to the image information database.

26. The navigation device according to claim 25, wherein the processor is on a server inside or outside a vehicle.

27. The navigation device according to claim 23, wherein
the processor further performs processes of,
generating attribution information in which visual information related to image information is extracted and converted into a text, and
updating the attribution information database by adding the attribution information to the attribution information database.

28. The navigation device according to claim 27, wherein
when the image information database is updated, the processor updates the attribution information database by using image information added to the image information database.

29. The navigation device according to claim 27, wherein when the image information database is updated, the processor updates the attribution information database by using image information added to the image information database, and, after that, deletes the image information from the image information database.

30. The navigation device according to claim 27, wherein the processor is on a server inside or outside a vehicle.

31. A navigation method comprising:
acquiring visual information about a destination;
generating a search condition by using the visual information about the destination; and
referring to an image information database having stored therein pieces of image information each about a neighborhood of a road and pieces of position information, to search for image information satisfying the search condition, and to set, as the destination, position information corresponding to the image information.
